(19) United States
(12) Patent Application Publication
(10) Pub. No.: US 2015/0072735 A1
(43) Pub. Date: Mar. 12, 2015

(54) MOBILE EQUIPMENT IDENTIFICATION NUMBER AND MOBILE INDEX NUMBER SHARING TO PROVIDE OPTIMAL COMMUNICATION IN A NETWORK

(71) Applicant: Cluster Wireless, LLC, San Diego, CA (US)

(72) Inventors: Robbin David Hughes, Plano, TX (US); Prem Jothipragasam Kumar, San Diego, CA (US); Thomas O'Neill, La Jolla, CA (US); Ramesh Rajasekharan, Chennai (IN)

(73) Assignee: Cluster Wireless, LLC, San Diego, CA (US)

(21) Appl. No.: 14/024,343

(22) Filed: Sep. 11, 2013

(51) Int. Cl. H04W 88/06; H04B 1/38

(52) U.S. Cl. CPC H04W 88/06; H04B 1/3816
USPC 455/558

(57) ABSTRACT

The present embodiment provides a method and system a method for sharing Mobile Equipment Identification Number (MEID) and Mobile Index Number (MIN) to provide optimal communication in a multi-service provider environment. The method includes receiving a request to access a service provided by one or more service providers, identifying a MEID-MIN pair associated with the request, and sharing the identified MEID-MIN pair among a plurality of access nodes associated with the one or more service providers. Further, the method further includes detecting an optimized access node among the plurality of access nodes to provide access to the service based on parameters associated with the plurality of access nodes, and using the identified MEID-MIN pair to provide access to the service through the detected optimized access node.

### TECHNICAL FIELD

The embodiments herein relate to a wireless communications network and, more particularly, to a mechanism for sharing Mobile Equipment Identification Number (MEID)-Mobile Index Number (MIN) pairs in a multi-service provider environment to provide optimal communication service in a network.

### BACKGROUND

Network services utilized by mobile devices are provided by various service providers and mobile virtual network operators. The mobile devices are generally equipped with Subscriber Identity Module (SIM) cards and Mobile Identification Equipment Number (MEID) to uniquely identify the device and their assignment in the network. Communication service is typically intermediated by the SIM card's direct service provider (home or local service provider). When the mobile device is outside the effective range of the direct service provider and within the effective range of another co-operative provider then the direct provider switches from direct access to access provided by the co-operative provider and incur roaming charges. Ideally, the mobile device stays in home system furnished by the direct service provider, and switches to a roaming system only when the home system is not available. The service provided by the roaming system can be based on various factors, such as a given level of quality of service, support for a particular service, availability for a particular service, bandwidth, security, roaming cost, congestion, or the like.

Different systems and methods are proposed to provide optimal communicaiton services to the users. The conventional systems allows the users to often have multiple SIM cards alternately inserted into their mobile device to manually select and access the optimal telecommunication services of local provider in different areas. Another mechanism automates this manual process by dynamically switching between the multiple SIM cards. These mechanisms may require the user to carry different SIM cards to access the optimal communication service. In yet another mechanism, grouping of access nodes associated with various service providers is performed to automatically provide the optimal communication service to the user. This may eliminate the need for the user to carry multiple SIM cards but, such mechanism may not be effective as the access nodes may not effectively exchange mobile device information and coordinate among each other which may further results in higher overall cost and lower performance of the group.

Though the existing systems and methods are effective to a degree in providing the optimal communication service in the network, they include both advantages and disadvantages in terms of service provider coordination, access points vicinity, service availability, subjective understanding of service parameters (such as cost, data plans, or the like), optimization, characteristics, types of wireless links, communication channels quality, time, cost, user preferences, range, speed, bandwidth, workload, congestion, and the like.

### BRIEF DESCRIPTION OF THE FIGURES

The embodiments herein will be better understood from the following detailed description with reference to the drawings, in which:

FIG. 1 illustrates generally, among other things, a system in which the present embodiment is embodied, according to embodiments disclosed herein;

FIG. 2 illustrates an example wireless network including mobile phone sharing MEIN-MIN pairs among access nodes as described in the FIG. 1, according to embodiments as disclosed herein;

FIG. 3 illustrates another example wireless network where controller is independently implemented, according to embodiments as disclosed herein;

FIG. 4 illustrates a flow diagram illustrating a method for sharing MEID and MIN to provide optimal communication in a multi-service provider environment, according to embodiments as disclosed herein; and

FIG. 5 is a computing environment implementing the system and method of the embodiment, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The term “or” used herein refers to a “nonexclusive or” unless otherwise indicated. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a system and method for sharing Mobile Equipment Identification Number (MEID) and Mobile Index Number (MIN) to provide optimal communication in a multi-service provider environment. In an embodiment, the multi-service provider environment includes an array of service providers capable of providing services requested by users in a communication network. Each service provider is associated with one or more access nodes configured to provide the service requested by the users based on various parameters. In an embodiment, the parameters described herein can include for example, but not limited to, service availability, access node characteristics, near-by access nodes, supported communication channel, link quality, link availability, profile data, user preferences, usage data, range, speed, service cost, data plan, bandwidth, workload, security data, congestion, or the like. Further, the system includes a controller configured to receive a request to access a service provided by the one or more service provider in the communication network. The controller is configured to identify MEID-MIN pair associated with the request and share the identified MEID-MIN pair among the access nodes associated with the one or more service providers capable of providing the service requested by the user. Unlike conventional systems, the present embodiment shares the MEID-MEIN pairs in the multi-service provider environment, such as to allow the service providers to effectively coordinate with each other and decide the optimal access node capable of providing the requested service to the user. Furthermore, the controller is configured to detect an optimized access node among the plurality of access nodes, in the multi-service provider environment, best suitable to provide the service based on the parameters associated with each access node. The controller is configured to use the identified MEID-MIN pair to provide the access to the requested service through the detected optimized access node.

The proposed system and method is simple, reliable, and robust for providing optimal communication in the multi-service provider environment by sharing MEID-MIN pairs throughout the multi-service provider environment. The automatic nature of the system and method may improve the user experience for accessing the optimal services and increases the system performance by significantly decreasing the overall system time and cost. Unlike conventional system, the present embodiment can be used to allow the set of users, operating in proximity or single user operating a device carrying multiple MEID-MINs pairs, to experience most cost-efficient and performance maximizing network access. The access to the service is derived from a wide array of underlying wireless systems owned by a multiplicity of network service providers. For example, for a given desired quality, the system and method can be used to provide a lowered average cost for the services to the user as they always utilize the optimum and cost-effective home services. Further, the system and method does not restrict the users to be associated with a particular service provider. As the users are no longer tethered to a particular service provider's network and billing regime, competition for the service cost, availability, quality, security, performance, or the like may also increase in wireless ecosystem and industry as a whole. Furthermore, the system can be used to increase the usage of the network services by dynamically selecting optimal access point capable of providing services based on the user requirements at a significantly lower average cost and quality. Unlike conventional systems, the system and method shares the MEID-MIN pairs in the multi-service provider environment to allow the service providers to effectively coordinate with each other. Further, the sharing of MEID-MIN pairs allows the system to effectively determine which access node (or network carrier) being received by various user devices in the communication network, which access node is used by the user devices to access the service in the network, which is the most suitable access node to provide the requested service on the user device, and which MEID-MIN pair is used in transaction with the access node while providing the requested service on the user device. Furthermore, the system and method can be used to provide seamless and uninterrupted service to the user by automatically selecting the most optimized access node in the multi-service provider environment. A complete optimal solution can be offered to the user by providing such seamless, optimal, and personalized services to the user. Furthermore, the proposed system and method can be implemented on the existing infrastructure and may not require extensive set-up or instrumentation.

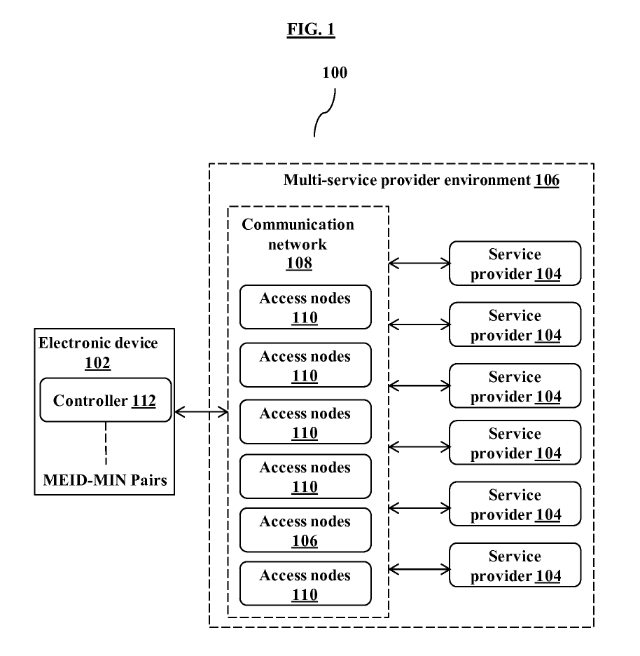

Referring now to the drawings, and more particularly to FIGS. 1 through 5, where similar reference characters denote corresponding features consistently throughout the figures, there are shown embodiments.

FIG. 1 illustrates generally, among other things, a system 100 in which the proposed embodiment is embodied, according to embodiments disclosed herein. The system 100 includes an electronic device 102 configured to access services offered by multiple service providers 104 in a multi-service provider environment 106 over a communication network 108. The multi-service provider environment 106 described herein includes an array of service providers capable of providing services requested by users in over the communication network 108. Each service provider 104 is associated with one or more access nodes 110 configured to provide the service requested by the electronic device 102. In an embodiment, the communication network 108 described herein can include for example, but not limited to, wireless network, wire line network, public network such as the Internet, private network, global system for mobile communication network (GSM) network, general packet radio network (GPRS), local area network (LAN), wide area network (WAN), metropolitan area network (MAN), cellular network, public switched telephone network (PSTN), personal area network, a combination thereof, or any other network.

In an embodiment, the access nodes 110 described herein can be for example, but not limited to, access point, base stations, Node B, evolved Node B (eNB), femtocell access point, picocell access point, microcell access point, macro access point, relay node, transmission controller, sensor, gateway device, router, hub, computer, laptop, wireless electronic device, personal digital assistance, smart phone, a combination thereof, or the like. Each access nodes 110 can be associated with one or more service providers 104 providing services which offers different advantages to the electronic device 102 in terms of service availability, access node characteristics, near-by access nodes, supported communication channel, link quality, link availability, profile data, user preferences, usage data, range, speed, service cost, data plan, bandwidth, workload, security data, congestion, or the like. Each access node 110 can be configured to include multiple wireless links such as for example, but not limited to, Bluetooth, ZigBee, Wi-Fi, P2P, ultra wideband, Near-field communication, or the like, such as to allow the user to experience most cost-efficient and performance maximizing the network access. Further, each access node 110 can include appropriate interfaces such to directly or indirectly communicate with the electronic device 102 and among each other over the network 102. The one or more service providers 104 can provide one or more services, such as to provide various functionalities and features to the user over the communication network 108. In an embodiment, the services described herein can include for example, but not limited to, telecommunication service, web services, financial services, transaction services, social services, multimedia services, business services, economic services, technical services, religious services, data services, printing services, ecommerce services, or any other type of service.

In an embodiment, the electronic device 102 described herein can be any computing device such as for example, but not limited to, cell phone, Smartphone, handheld computer, laptop computer, notebook computer, tablet device, slate device, media player, Personal Digital Assistant (PDA), camera, video camera, communicator, desktop computer, consumer electronic device, or the like. Generally, the electronic device 102 can include a variety of optional hardware and software components which may communicate with other components, although not all connections are shown, for ease of illustration. Each electronic device 102 can be configured to include multiple wireless links such as for example, but not limited to, Bluetooth, ZigBee, Wi-Fi, P2P, ultra wideband, Near-field communication, or the like to communicate with the access nodes 110. The electronic device 102 can be configured to include interfaces to connect with the access nodes 110 throughout the communication network 108.

Further, each electronic device 102 can be configured to include a Mobile Equipment Identifier (MEID) and Mobile Index Number (MIN) pairs. In an embodiment, MEID described herein refers to a globally unique number identifying a physical piece of the mobile station equipment. In an embodiment, MIN described herein can be a mobile number associated with the electronic device 102. Each electronic device 102 can include multiple MINs defining different MEID-MIN pairs. For example, if a mobile device is associated with three MINs namely, MIN1, MIN2, and MIN3 respectively, then the MEID-MIN pairs associated with the mobile device include MEID-MIN1, MEID-MIN2, and MEID-MIN3, respectively. Unlike conventional system, the system 100 can be used to allow the set of users, operating in proximity or single user operating the electronic device 102 carrying multiple MEID-MINs pairs to experience most cost-efficient and performance maximizing network access. The access to the service is derived from the wide array of underlying wireless systems, such as the access node s110, owned by the multiplicity of network service providers 104.

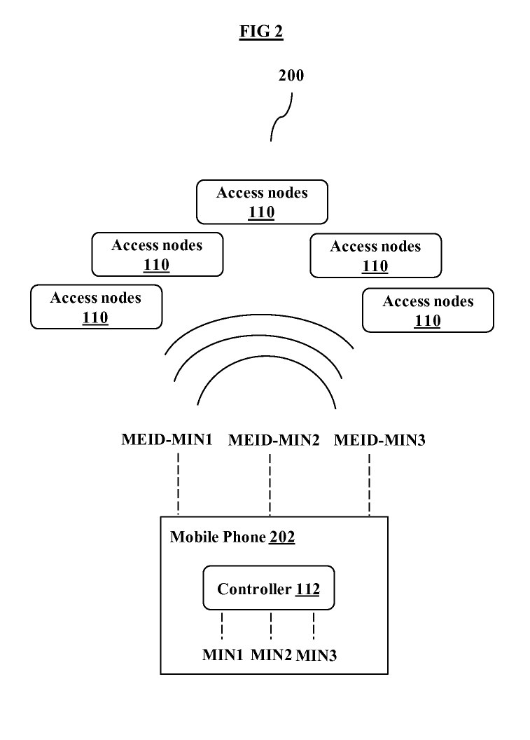

In an embodiment, the electronic device 102 includes a controller 112 capable of coordinating the service requests and processing data to provide the requested (desired) services. The controller 112 can be configure to share the MEID-MIN pairs associated with the electronic device 102 with the access nodes 110 associated with one or more service providers 104 in the multi-service providers environment 106. Unlike conventional systems, the controller 112 shares the MEID-MIN pairs in the multi-service provider environment 106 to allow the service providers 104 to effectively coordinate with each other. Further, the controller 104 can be configured to monitor and receive one or more parameters associated with each access node 110 in the communication network 108. In an embodiment, the parameters described herein can include for example, but not limited to, service availability, access node characteristics, near-by access nodes, supported communication channel, link quality, link availability, profile data, user preferences, usage data, range, speed, service cost, data plan, bandwidth, workload, security data, congestion, or any other parameter. Further, when a user requests a service, the controller 112 can be configure to detect an optimized access node among the plurality of access nodes 110, in the multi-service provider environment 106, best suitable to provide the service based on the parameters associated with each access node 110. The various operations performed by the system 100 are described in conjunction with FIGS. 2 through 4.

Further, in an embodiment, the controller 112 described herein can be implemented independently as a standalone component or dependently through other components using z computer program, software module, hardware module or a combination thereof. Furthermore, hardware portions corresponding to the system 100 may be included to provide the transmission and reception of signals among the devices 106, such as to provide the effective services to the user. Although the FIG. 1 shows a limited set of the multi-service providers in the environment 106, but it is to be understood that another embodiment is not limited thereto. Furthermore, the access nodes 110 also be coupled with each other and may be able to communicate directly, indirectly, remotely, via third-party devices or networks among each other. In other embodiments, system 100 may include more, fewer, or different components. Moreover, one or more devices associated with the network may perform one or more functions or operations of any other device. Furthermore, the system 100 can be configured to include various techniques and technologies to enable wireless communication throughout the system. The techniques and technologies described herein can include for example, but not limited to, Code Division Multiple Access (CDMA), Wideband CDMA (WCDMA), Time Division Multiple Access (TDMA), Frequency Division Multiple Access (FDMA), Orthogonal Frequency-Division Multiple Access (OFDMA), Single Carrier FDMA (SC-FDMA), Global System for Mobile Communications (GSM), Universal Mobile Telecommunication System (UMTS), 3rd Generation Partnership Project (3GPP) Long Term Evolution (LTE), Ultra Mobile Broadband (UMB), Institute of Electrical and Electronics Engineers (IEEE) 802.11 (Wi-Fi), IEEE 802.16 (Wi-Max), IEEE 802.20, and or like.

FIG. 2 illustrates an example wireless network 200 including a mobile phone 202 sharing MEIN-MIN pairs among access nodes as described in the FIG. 1, according to embodiments as disclosed herein. An example illustration implementing the controller 112 dependently using a mobile phone 202 is shown in the FIG. 2. The figure depicts the electronic device 102 as the mobile phone 202 (which is a home wireless device) connected using a Wi-Fi, Bluetooth or the like with the one or more access nodes 110. Each access node 110 can be associated with one or more service provider 104 providing services to the mobile phone 202. Each service provider 104 can provide the service using different network or based on the different parameters associated with the access node 110. For example, some of the access nodes may be connected to an AT & T network, some other access nodes may be connected to a Sprint network, yet some other access nodes may be connected to a Verizon network, or the like. Each access node 110 providing services requested by the mobile device 202 based on different parameters offering different advantages in terms of service availability, access node characteristics, near-by access nodes, supported communication channel, link quality, link availability, profile data, user preferences, usage data, range, speed, service cost, data plan, bandwidth, workload, security data, congestion, or the like.

The mobile phone 202 described herein is associated with three MINs namely, MIN1, MIN2, and MIN3 respectively defining different MEID-MIN pairs namely, MEID-MIN1, MEID-MIN2, and MEID-MIN3, respectively. The controller 112 can be used to allow the set of mobile phones operating in proximity or single mobile phone 202 carrying multiple MEID-MINs pairs to experience most cost-efficient and performance maximizing network access. The access to the service is derived from the wide array of underlying the access nodes 110, owned by the multiplicity of network service providers 104. In an embodiment, the controller 112 can be configured to receive a request to access one or more services in the wireless network 200. The controller 112 can be configured to coordinate the service requests and process the data to provide the requested (desired) services to the mobile phone 202. The controller 112 can be configured to identify the MEID-MIN pair associated with the mobile phone 202 using the request data and share the MEID-MIN pair among the access nodes 110. For example, if the mobile phone 202 uses the MIN1 to originate a call then the controller 112 identify the MEID-MIN pair as MEID-MIN1 and share the MEID-MIN1 pair with all the access nodes 110 in the wireless network 200. The sharing of the MEID-MIN1 pair with the access nodes 110 in the wireless network 200 allows the service providers 104 to effectively coordinate with each other. Further, the sharing of MEID-MIN pairs allows the controller 112 to effectively determine which access node 110 is being received by the mobile phone 202 in the wireless network 200, which access node 110 is used by the mobile phone 202 to access the service in the wireless network 200, which is the most suitable access node 110 to provide the requested service on the mobile phone 202, and which MEID-MIN pair is used in transaction with the access node 110 while providing the requested service on the mobile phone 202.

In an embodiment, the controller 112 can be configured to receive the one or more parameters associated with the access nodes 110. Each device in the wireless network 200 can be associated with a number of corresponding parameters that can be tuned to affect the performance and responsiveness of the system 100. When the mobile device 202 requests the service, the controller 112 can be configure to detect an optimized access node among the plurality of access nodes 110, best suitable to provide the service based on the parameters associated with each access node 110. The parameters described herein can include for example, but not limited to, service availability, access node characteristics, near-by access nodes, supported communication channel, link quality, link availability, profile data, user preferences, usage data, range, speed, service cost, data plan, bandwidth, workload, security data, congestion, or any other parameter.

For example, when the mobile phone 202 request for to perform a Skype call then the controller 112 searches for the available access nodes 110 best suitable to provide the service based on the associated parameters. The controller identifies that the access node 110 which is connected in the Sprint network offers less cost compared to the access node 110 connected in the Verizon network. Hence, the controller 110 selects the access node 110 which is connected in the Sprint network and shares the MEID-MID1 pair among the other access nodes 110 indicating that the MEID-MID1 pair is best served by the access nodes 110 (which is connected in the Sprint network) such that the other access nodes 110 can coordinate and compete to provide the most optimized service. As the users are no longer tethered to a particular service provider's network and billing regime, competition for the service cost, availability, quality, security, performance, or the like may also increase in wireless ecosystem and industry as a whole.

In another example, if the user of the mobile phone 202 wants to play a recording which is in .WMA (Windows Media Audio) file format stored in mobile phone memory. But, the mobile phone 202 does not support the .wma format then the mobile phone 202 sends a request to play the recording using a network device (such as access node 110) associated with one or more service providers. The controller 112 can be configured to detect the most optimized network device to play the recording using the parameters associated with the different network devices.

In an embodiment, the controller 112 can also allow the users to select the optimum access node 110 among the available access nodes 110 to avail the desired service in the network. In such scenario, the service provides 104 can provide an option to select an access node 110 using the electronic device 102. Further, the controller 112 can be configured to constantly monitor the access nodes 110 and their associated parameters. Any changes in these parameters can affect the performance, sensitivity, cost, and reliability of the system 100. The constant monitoring of the parameters can allow the controller 112 to provide seamless, optimal, personalized, reliable, uninterrupted, and enhanced services to the user.

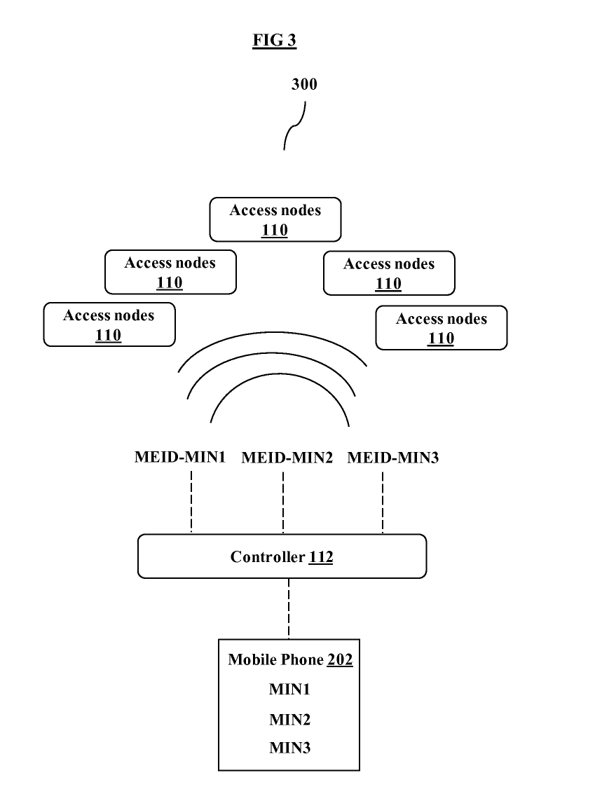

FIG. 3 illustrates another example wireless network 300 where the controller 112 is independently implemented, according to embodiments as disclosed herein. In an embodiment, the controller 112 can be implemented independently as a standalone component or dependently through other components using computer program, software application, hardware module or a combination thereof. An example illustration of implementing the controller 112 independently as a standalone component is shown in the FIG. 3.

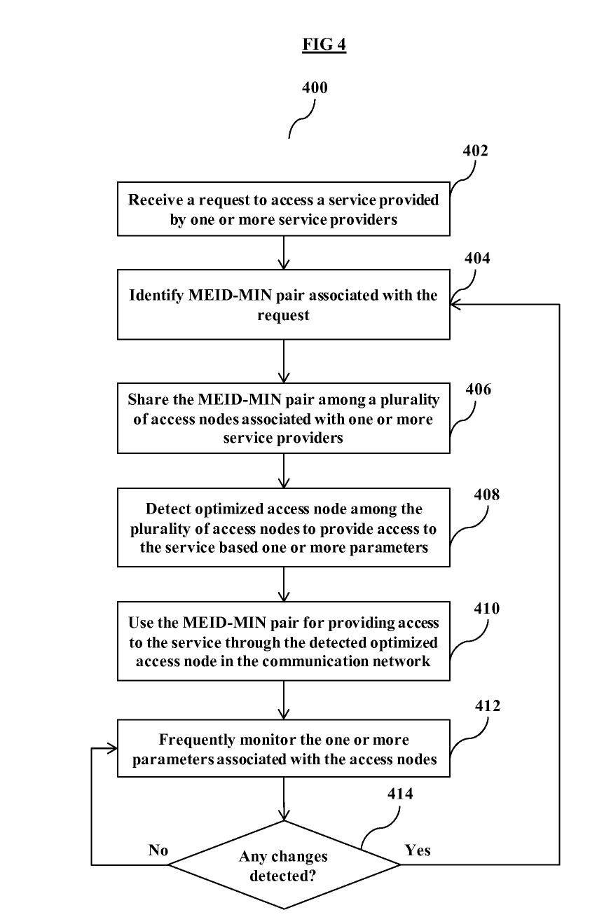

FIG. 4 illustrates a flow diagram illustrating a method 400 for sharing MEID and MIN to provide optimal communication in the multi-service provider environment 106, according to embodiments as disclosed herein. The method 400 and other description described herein provide a basis for a control program which can be implemented using a microcontroller, microprocessor, or a combination thereof. In an embodiment, the multi-service provider environment 106 can include array of service providers 104 capable of providing services requested by users in the communication network 108. Each service provider is associated with the one or more access nodes 110 configured to provide the service requested by the user.

In an embodiment, at step 402, the method 400 includes receiving a request to access one or more services provided by other or more service providers 104. In an example, the method 400 allows the network controller 112 to receive the service request from the electronic device 102. In an embodiment, at step 404, the method 400 includes identifying the MEIN-MIN pair associated with the request. Each electronic device 102 is associated with an MEIN-MIN pair. In an example, the method 400 allows the controller 112 to identify the MEIN-MIN pair using the request data, such as to identify which MEIN-MIN pair is responsible for originating the transaction.

In an embodiment, at step 406, the method 400 includes sharing the identified MEID-MIN pair among the plurality of access nodes 110 associated with the one or more service providers 104 capable of providing the service requested by the electronic device 102. In an embodiment, the method 400 allows the controller 112 to share the MEID-MEIN pairs in the multi-service provider environment 106, such as to allow the service providers 104 to effectively coordinate with each other and decide the optimal access node 110 capable of providing the requested service to the user. Further, the sharing of the MEID-MIN pair allows the controller 112 to effectively determine which access node 110 being received by the electronic device 102 in the communication network 108, which access node 110 is used by the electronic device 102 to access the service in the communication network 108, which is the most suitable access node 110 to provide the requested service on the electronic device 102, and which MEID-MIN pair is used in the transaction with the access node 110 while providing the requested service on the electronic device 102.

In an embodiment, at step 408, the method 400 includes detecting the optimized access node among the plurality of access nodes 110 to provide access to the service based one or more parameters. Each access node 110 in the communication network 108 can be associated with a number of corresponding parameters (1-N) that can be tuned to affect the performance and responsiveness of the controller 112. In an example, the method 400 allows the controller 112 to send request to the access nodes 110 to receive the parameters associated with them throughout the communication network 108. The parameters described herein can include for example, but not limited to, service availability, access node characteristics, near-by access nodes, supported communication channel, link quality, link availability, profile data, user preferences, usage data, range, speed, service cost, data plan, bandwidth, workload, security data, congestion, or any other parameter. Further, the method 400 allows the controller 112 is to detect the optimized access node among the plurality of access nodes 110, in the multi-service provider environment, best suitable to provide the service based on the parameters associated with each access node 110. For example, the controller 112 can execute one or more rules to detect the optimized access node to provide the requested service. The rules can include various combination of elements such as for example, but not limited to, service availability, access node characteristics, near-by access nodes, supported communication channel, link quality, link availability, profile data, user preferences, usage data, range, speed, service cost, data plan, bandwidth, workload, security data, congestion, or the like.

In an embodiment, at step 410, the method 400 using the MEID-MIN pair for providing access to the service through the detected optimized access node in the communication network 108. In an example, the method 400 allows the controller to 112 to use the detected optimized access node to provide the desired service on the electronic device 102. As the MEIN-MIN pair is already shared with the access nodes, the controller 112 uses the shared MEIN-MIN pair during the transactions. Further, the information about the optimized access node using the shares the MEID-MID pair indicates to other access nodes that the particular MEID-MID pair is best served by the optimized access node such that the other access nodes 110 can coordinate and compete to provide the most optimized service. As the users are no longer tethered to a particular service provider's network and billing regime, competition for the service cost, availability, quality, security, performance, or the like may also increases.

In an embodiment, at step 412, the method 400 includes constantly monitoring the parameters associated with the access nodes 110, such as to automatically manage and switch among the most optimized access nodes offering the desired service. The constant monitoring of the device parameters can allow the controller 112 to provide seamless, optimal, personalized, reliable, uninterrupted, and enhanced services to the user. In an embodiment, at 414, the method 400 includes determining any changes or any new access node entered the network. In an example, the method 400 allows the controller 112 to detect changes in the parameters of the access nodes 110 or if any new access node is added or deleted in the network 108. Any changes in the parameters can affect the performance, sensitivity, cost, and reliability of the controller 112. In an embodiment, upon detecting any changes in the parameters, the method 400 includes repeating the steps 404 through 414 such as to provide the seamless and uninterrupted service to the user.

The various actions units, steps, blocks, and acts described in the method 400 may be performed in the order presented, in a different order, or simultaneously. Further, in some embodiments, some actions, units, steps, blocks, and acts listed in the FIG. 4 may be omitted, added, skipped, and modified without departing from the scope of the embodiment.

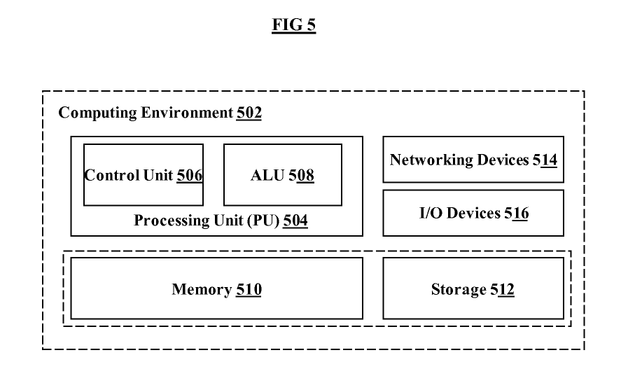

FIG. 5 illustrates a computing environment 502 implementing the method and systems as disclosed in the embodiments herein. As depicted the computing environment 502 comprises at least one processing unit 504 that is equipped with a control unit 506 and an Arithmetic Logic Unit (ALU) 508, a memory 510, a storage unit 512, plurality of networking devices 514 and a plurality Input output (I/O) devices 516. The processing unit 504 is responsible for processing the instructions of the algorithm. The processing unit 504 receives commands from the control unit 506 in order to perform its processing. Further, any logical and arithmetic operations involved in the execution of the instructions are computed with the help of the ALU 508.

The overall computing environment 502 can be composed of multiple homogeneous and/or heterogeneous cores, multiple CPUs of different kinds, special media and other accelerators. The processing unit 504 is responsible for processing the instructions of the algorithm. Further, the plurality of processing units 504 may be located on a single chip or over multiple chips.

The algorithm comprising of instructions and codes required for the implementation are stored in either the memory unit 510 or the storage 512 or both. At the time of execution, the instructions may be fetched from the corresponding memory 510 and/or storage 512, and executed by the processing unit 504. In case of any hardware implementations various networking devices 514 or external I/O devices 516 may be connected to the computing environment to support the implementation through the networking unit and the I/O device unit.

The embodiments disclosed herein can be implemented through at least one software program running on at least one hardware device and performing network management functions to control the elements. The elements shown in FIGS. 1 through 5 include blocks, steps, operations, and acts, which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for sharing Mobile Equipment Identification Number (MEID) and Mobile Index Number (MIN) to provide optimal communication in a multi-service provider environment, the method comprising:
receiving a request to access at least one service provided by at least one service provider;
identifying at least one MEID-MIN pair associated with said request;
sharing said at least one identified MEID-MIN pair among a plurality of access nodes associated with said at least one service provider;
detecting at least one optimized access node among said plurality of access nodes to provide access to said service based on at least one parameter associated with said plurality of access nodes; and
using said at least one identified MEID-MIN pair for providing access to said service through said detected optimized access node.

2. The method of claim 1, wherein said multi-service provider environment comprises an array of service providers capable of providing said at least one service requested by an electronic device.

3. The method of claim 2, wherein each service provider is associated with at least one access node configured to provide said at least one service requested by said electronic device.

4. The method of claim 1, wherein said at least one parameter associated with said plurality of access nodes comprises at least one of service availability, access node characteristics, near-by access nodes, supported communication channel, link quality, link availability, profile data, user preferences, usage data, range, speed, service cost, data plan, bandwidth, workload, security data, and congestion.

5. The method of claim 1, wherein each access nodes comprises multiple wireless links to provide said access to said service.

6. The method of claim 5, wherein at least one wireless link from said multiple wireless links is used to provide access to said service through said optimized access node.

7. The method of claim 1, wherein the method further comprises receiving at least one parameter associated with said plurality of access nodes;

8. The method of claim 1, wherein the method further comprises constantly monitoring said at least one parameter associated with said plurality of access nodes.

9. The method of claim 8, wherein said method further comprises dynamically switching among at least one optimized node in multi-service provider environment based on said monitoring.

10. A system for sharing Mobile Equipment Identification Number (MEID) and Mobile Index Number (MIN) to provide optimal communication in a multi-service provider environment, the system comprising a controller configured to:
receive a request to access at least one service provided by at least one service provider,
identify at least one MEID-MIN pair associated with said request,
share said at least one identified MEID-MIN pair among a plurality of access nodes associated with said at least one service provider,
detect at least one optimized access node among said plurality of access nodes to provide access to said service based on at least one parameter associated with said plurality of access nodes, and
use said at least one identified MEID-MIN pair for providing access to said service through said detected optimized access node.

11. The system of claim 10, wherein said multi-service provider environment comprises an array of service providers capable of providing said at least one service requested by an electronic device.

12. The system of claim 11, wherein each service provider is associated with at least one access node configured to provide said at least one service requested by said electronic device.

13. The system of claim 10, wherein said at least one parameter associated with said plurality of access nodes comprises at least one of service availability, access node characteristics, near-by access nodes, supported communication channel, link quality, link availability, profile data, user preferences, usage data, range, speed, service cost, data plan, bandwidth, workload, security data, and congestion.

14. The system of claim 10, wherein each access nodes comprises multiple wireless links to provide said access to said service.

15. The system of claim 14, wherein at least one wireless link from said multiple wireless links is used to provide access to said service through said optimized access node.

16. The system of claim 10, wherein the controller is further configured to receive at least one parameter associated with said plurality of access nodes;

17. The system of claim 10, wherein the controller is further configured to constantly monitor said at least one parameter associated with said plurality of access nodes.

18. The system of claim 17, wherein the controller is further configured to dynamically switch among at least one optimized node in said multi-service provider environment based on said monitoring.

19. A computer program product for sharing Mobile Equipment Identification Number (MEID) and Mobile Index Number (MIN) to provide optimal communication in a multi-service provider environment, the product comprising:
an integrated circuit comprising at least one processor;
at least one memory having a computer program code within said circuit, wherein said at least one memory and said computer program code with said at least one processor cause said product to:
receive a request to access at least one service provided by at least one service provider,
identify at least one MEID-MIN pair associated with said request,
share said at least one identified MEID-MIN pair among a plurality of access nodes associated with said at least one service provider,
detect at least one optimized access node among said plurality of access nodes to provide access to said service based on at least one parameter associated with said plurality of access nodes, and
use said at least one identified MEID-MIN pair for providing access to said service through said detected optimized access node.

20. The computer program product of claim 19, wherein said multi-service provider environment comprises an array of service providers capable of providing said at least one service requested by an electronic device.

21. The computer program product of claim 20, wherein each service provider is associated with at least one access node configured to provide said at least one service requested by said electronic device.

22. The computer program product of claim 19, wherein said at least one parameter associated with said plurality of access nodes comprises at least one of service availability, access node characteristics, near-by access nodes, supported communication channel, link quality, link availability, profile data, user preferences, usage data, range, speed, service cost, data plan, bandwidth, workload, security data, and congestion.

23. The computer program product of claim 19, wherein each access nodes comprises multiple wireless links to provide said access to said service.

24. The computer program product of claim 23, wherein at least one wireless link from said multiple wireless links is used to provide access to said service through said optimized access node.

25. The computer program product of claim 19, wherein said at least one memory and said computer program code with said at least one processor cause said product to receive at least one parameter associated with said plurality of access nodes;

26. The computer program product of claim 19, wherein said at least one memory and said computer program code with said at least one processor cause said product to constantly monitor said at least one parameter associated with said plurality of access nodes.

27. The computer program product of claim 26, wherein said at least one memory and said computer program code with said at least one processor cause said product to dynamically switch among at least one optimized node in multi-service provider environment based on said monitoring.
